(19) United States
(12) Patent Application Publication
(10) Pub. No.: US 2024/0044511 A1
(43) Pub. Date: Feb. 8, 2024

(54) METHOD FOR MONITORING A COOKING PROCESS, AND CONTROL DEVICE

(71) Applicant: BSH Hausgeräte GmbH, Munich (DE)

(72) Inventors: Christopher Heckmann, Bretten (DE); Gerald Horst, Karlsruhe (DE); Barbara John, Bruchsal (DE); Frank Schaefer, Puchheim (DE); Daniel Vollmar, Pfinztal (DE)

(21) Appl. No.: 18/021,199

(22) PCT Filed: Jul. 21, 2021
(86) PCT No.: PCT/EP2021/070360

§ 371 Date: Aug. 15, 2023

(30) Foreign Application Priority Data
Aug. 18, 2020 (DE) 10 2020 210 481.6

(51) Int. Cl. F24C 15/20; A47J 36/32

(52) U.S. Cl. CPC F24C 15/20; A47J 36/321

(57) ABSTRACT

In a method for monitoring a cooking process, a movement of an object in an area of a cooktop is detected. The detected movement is evaluated for a predetermined time. An indicator of a development of smoke in the area of the cooktop is detected and evaluated, and a warning signal is being output when a movement for the predetermined time is absent and the indicator is present.

The present invention relates to a method for monitoring a cooking process and to a control device.

Smoke alarms are generally used for warning purposes in the event of a fire and the development of smoke associated therewith. However, conventional smoke and fire alarms are not used in kitchens since they respond to vapors produced during cooking. In other words, these would result in false alarms in the kitchen environment as a result of the development of steam and smoke often caused by the cooking process thereby rendering an installation in this area impractical.

Cooktops nevertheless pose a significant risk of a fire occurring, if, for instance, incorrect use or a specific cooking process brings about an increased fire hazard. There is therefore a need to improve fire protection in kitchen areas.

Furthermore, particles may also form during the cooking process, for instance during grilling or searing, which are part of the normal cooking process or are even desired and do not cause any hazard during the preparation of the food to be cooked. In these cases, the triggering of an alarm is unwanted and is perceived to be disagreeable by the user who is present during the preparation.

The object of the present invention is therefore to create a solution which at least reduces the disadvantages of the prior art. A fire alarm or smoke alarm is preferably only provided here selectively without however extensively changing the complexity of a cooking system.

This object is achieved according to the invention by a method for monitoring a cooking process. Here the method comprises the following steps:
detecting a movement of an object in the area of a cooktop; and
evaluating the detected movement for a predetermined time.

In accordance with the invention, an indicator of a development of smoke in the area of the cooktop is also detected and evaluated and a warning signal is output in the absence of a movement for the predetermined time and in the presence of an indicator.

In this way, a user who is not located at the cooktop can be made aware of a potential hazard and in particular react promptly if smoke were to form during the cooking process in order to prevent a fire from developing and/or polluting the kitchen air. However, if the user is present and involved in the cooking process, it is assumed therefrom that corresponding movements of objects are detected in the area of the cooktop, so that the user does not have to be made aware of a development of smoke and to a lesser degree this may likewise be desired during a roasting or grilling process, for instance.

The predetermined time during which no movement is detected and after which a warning signal can be output preferably corresponds here to a time which enables the user to initiate corresponding measures, even before a development of smoke causes the kitchen air to become significantly polluted or a fire to develop. For instance, the predetermined time can amount to a time interval of between approximately one second and approximately five seconds.

Here, during the evaluation of the indicator, provision can likewise be made for a course of the development of smoke, wherein the predetermined time is adjusted on the basis of the course. Therefore, a significant development of smoke or a progressive or gradual worsening can be taken into account and the predetermined time can be shortened accordingly when a predetermined threshold value is exceeded. To this end, empirical values and/or characteristic curves can be stored in a corresponding control device, for instance. In other words, the predetermined time can likewise be adjusted dynamically to a course of the indicator.

The selective output of the warning signal is therefore carried out on the basis of a detected movement or an absence of a movement in the area of the cooktop. The movement of an object can be detected here easily by a camera. These movements are to some extent already detected in order to identify gestures and to control fume extraction devices and/or cooktops on account of these gestures, for instance. Therefore, the detection of movements is advantageous in that given detection units, such as cameras for instance, can be used.

The movement in the area of the cooktop can comprise the movement of a hand of the user, the movement of a head of the user, the movement of a cooking utensil and/or the movement of food to be cooked. Accordingly, a movement and optionally a course of the movement can be interpreted as the user's intended activity for a specific cooking receptacle or a corresponding cover of the cooking receptacle. Similarly, the movement of the head of the user or of a cooking utensil in the area of a cooking receptacle can show that the user is actively involved in the cooking process and can thus independently notice a development of smoke.

The existence of smoke particles or dust particles can serve as an indicator of a development of smoke. Similarly, a sudden change in a detected vapor, for instance density and/or flow rate, and a sudden increase in temperature can serve as an indicator of a development of smoke.

Should such a development of smoke be detected and no movement be detected by the user for the predetermined time, a warning signal is correspondingly output. The warning signal can be output here visually and/or acoustically. For instance, a light and/or a buzzer can be provided so that when the warning signal is output, a visual or acoustic alarm is output. In this way, a user can be made aware of a potential hazard and an imminent development of smoke and/or fire even before this event actually occurs and thus prevent the kitchen air from becoming polluted and a potentially hazardous situation of boiling over, for instance by displacing the corresponding cooking receptacle, closing the lid and/or adjusting the fan power of the fume extraction device and/or the cooking level of the respective cooking zone.

The warning signal preferably comprises an output of information and/or a notification to the user and/or a control and/or regulating signal for controlling an operating state of a fume extraction device and/or the cooktop.

Accordingly, a user absent from the cooking process can be notified even before a fire develops or smoke is able to spread. For instance, the warning signal or the information output or notification can be transferred by means of Wi-Fi (Direct), Bluetooth, radiofrequency (RF), infrared signal, of a “hood-hob-connect” or also by way of an existing internet connection such as HCA or Home Connect to a coupled terminal of the user, preferably by way of a preinstalled app, which receives this notification in the background periodically or by means of the push notification or in the active state continuously receives the same. Furthermore, the message can likewise comprise a video sequence of a detected video or also a live transfer of currently detected images or video sequences.

A control and/or regulating signal further enables smoke to spread and/or fire to be prevented, by, for instance, the fume extraction device being switched off or a corresponding fan power being lowered, for instance, in order thus to avoid fueling a fire. At the same time, a cooking level of the respective cooking zone, which is assigned to the cooking receptacle, can likewise be lowered or reduced accordingly, or also to at least partially deactivate the entire cooktop.

Furthermore, the control and/or regulating signal can bring about an adjustment of the operating mode of the fume extraction device and/or of the cooktop and/or an adjustment of the sampling rate of the detection. For instance, the fan power of the fume extraction device can be switched off or operated at a basic output, wherein a predetermined power level is not exceeded. Provision can also be made for an adjustment of the sampling rate of a detection unit, so that a monitoring algorithm can be carried out, which enables a sensitive regulation for instance and likewise takes into account a course of the indicator and in the process minimal changes to the indicator or also increases the size of the area of detection in order to be able to detect possible movements of the user on an edge region of the cooktop.

Control of the fume extraction device can take place here using empirical values with different indicators or courses of an indicator. These values or characteristic curves can be stored for instance in a control device and/or be saved and exist in an algorithm of a control device by means of a corresponding programming. The detection and evaluation preferably takes place here continuously, for instance if the cooktop and/or the fume extraction device has been activated or a change in temperature on the cooktop is detected. The evaluation can take place here over a predetermined time.

By selectively outputting the warning signal with the control and/or regulating signal, it is therefore possible to react promptly to an imminent development of smoke and/or a potential fire even before this event actually occurs. Here a user's interaction in terms of reaction to a development of smoke by outputting the warning signal is namely desired and possible, but not absolutely necessary, since the control and/or regulating signal enables an automatic control of the fan power of the fume extraction device, for instance. Therefore, an unwanted fueling of a fire is prevented and an initial fire is choked should it occur. As a result, a spread of a smoke cloud is likewise effectively prevented. As soon as the indicator then shows that no smoke is present, the fan power can be increased again accordingly so that any smoke particles possibly remaining can be effectively extracted and the cooking process continued.

The indicator is preferably a predetermined change in contrast and/or a predetermined brightness of at least one subarea of at least one detected image within a predetermined time, wherein the image comprises the area of the cooktop.

For instance, in this way a development of smoke can be detected, wherein soot particles are formed, wherein a compression and change in the contrast of the air located above a cooktop is effected by means of the soot particles or dust particles present. Such a change is generally not present or at least not to the same degree in the case of a vapor which typically occurs during the cooking process. Alternatively or in addition, a brightness or also a brightness course of the detected image can as a result likewise be determined during the evaluation of the image. In this way the presence of a development of smoke can already be perceived in a starting phase. In order to differentiate this from a typical vapor or a vapor cloud, values or characteristic curves can also be stored in a control device and/or processed in a corresponding algorithm, for instance. The changes in contrast and/or brightness courses can also be used to detect specific patterns and courses within the predetermined time, wherein this can likewise occur for and between a number of levels or heights above the cooktop.

Furthermore, a developing fire can be determined on the basis of the change in contrast and/or the brightness course or an absolute brightness, if for instance threshold values are exceeded for absolute brightness values and/or a change in contrast or a brightness spreads or is distributed across a predetermined area. By detecting the changes in contrast and/or the brightness, different states and, if applicable, hazards can be determined during the cooking process, wherein the warning signal is preferably classified and output on the basis of the corresponding hazard.

Furthermore, the at least one detected image can be an infrared image or an image with overlaid infrared data. In this way the accuracy of the indicator can be increased by taking into account a heat development, so that an indicator of a development of smoke is for instance only then detected or interpreted as an indicator of a development of smoke if a threshold value of an absolute temperature, a surface temperature and/or a temperature distribution across the cooktop is exceeded. In this way, developing soot particles can for instance likewise be distinguished better from a vapor or a steam cloud.

On the basis of an evaluation result, a probability of a fire developing can also be determined, wherein the warning signal can correspond to the determined probability. In other words, the warning signal can be classified on the basis of a determined existing hazard, wherein for instance an only minimal development of smoke does not represent an acute fire hazard, and for instance only a visual warning light attached to a fume extraction device can be illuminated. In contrast, with a development of fire, an immediate switching-off of the fume extraction device and a notification to the user can be triggered, for instance by means of a push message. Optionally the notification can here comprise a video sequence of a detected video or also a live transmission of currently detected images or video sequences.

The fire development can be determined here, as described above, on the basis of changes in contrast, brightness distributions and/or infrared data, which are evaluated in an evaluation unit, wherein a prediction of a development of fire takes place on the basis of a comparison with stored comparison values and/or characteristic curves in a prediction unit. The probability can also be determined on the basis of detected sensor data, wherein the sensor data preferably comprises sensor data of a measured air quality, a measurement of dust particles and/or soot particles, a measurement of the air humidity and/or an ambient temperature measurement.

For instance, sensors such as air quality sensors, VOC sensors (“volatile organic compound” sensors), PM 2.5 dust particle sensors, humidity sensors and temperature sensors can be used, which can be arranged on the fume extraction device in the form of an extractor hood, for instance, so that the properties of the air flowing through the extractor hood can be detected and evaluated and taken into account during the prediction of a probability of a development of fire. Therefore, for instance, when a corresponding change in contrast is detected, a detection of already a small quantity of dust particles or soot particles or also a corresponding increase in temperature can assist the prediction and further improve accuracy. Similarly, a comparatively minimal air humidity can indicate the absence of a requisite cooking fluid and a corresponding overheating of the food to be cooked, as a result of which smoke and a potential fire can subsequently be formed.

Accordingly, the probability can furthermore be determined on the basis of a detected temperature and/or type of food to be cooked which is located in a cooking receptacle on the cooktop. Therefore, the temperature of the food to be cooked can be detected for instance on the basis of a roasting sensor or infrared sensor, wherein a low temperature can be indicative of a low probability of a fire developing, even when a development of smoke was determined on the basis of the indicator. Conversely, a high temperature, which possibly even lies above the boiling point of a liquid to be provided during the cooking process, can indicate a complete evaporation and/or an imminent probability of smoke and fire.

On the basis of the type of food to be cooked, it is furthermore possible to classify the probability, which for instance can lie at zero with water and accordingly higher with other liquids such as milk, oil and roasting fat. The type of food to be cooked can be stored in a control device for instance or also be determined by means of a camera and corresponding algorithms or characteristic values.

Similarly, the probability can further be determined on the basis of a current recipe section of a stored recipe. For instance, an assistance function may be present in the cooking system, wherein the user executes a cooking process or a recipe gradually.

Here, in one or more steps, searing can be provided for instance, wherein a corresponding development of soot and/or dust particles or also a surge of vapor may occur. In such cases, provision can be made for different threshold values to be used for the indicator or also the prediction of a fire, in order not to unnecessarily restrict a cooking process or to furthermore retain or even raise a set fan power of the fume extraction device in order to anticipate this. A sampling rate or the predetermined time are accordingly not adjusted or shortened and can even be lengthened accordingly, wherein a warning signal can likewise optionally be suppressed.

If such recipe sections are not present however and a low cooking level or a cooking process is provided with a closed cover, for instance, the monitoring of the cooking process can remain unchanged or a sampling rate or the predetermined time can optionally be shortened in order to detect a movement.

According to a further aspect, the present invention relates to a control device for a cooking system. The control device comprises a detection unit for detecting a movement of an object in the area of a cooktop and an evaluation unit for evaluating the detected movement over a predetermined time. The control device is characterized in that the detection unit is designed to detect an indicator of a development of smoke in the area of the cooktop and the evaluation unit is designed to evaluate the indicator, wherein the control device comprises a control unit, which is designed to output a warning signal in the absence of a movement for the predetermined time and in the presence of an indicator.

Advantages and features which are described in respect of the inventive method apply, if applicable, accordingly to the inventive control device and vice versa.

The control device can be integrated in a fume extraction device, for instance in the form of an extractor hood, or embodied as a module, which can be fastened to an extractor hood, and comprises a communication unit for the wireless transmission of data between the control device and the extractor hood and/or between the control device and the cooktop. The module can be integrated here for instance in an extractor hood. In this case, the extractor hood is preferably connected to the cooktop by way of which this is arranged for data exchange. This connection can be a wired or wireless connection.

Alternatively it is also possible for the control device to represent a module which is arranged separately from the fume extraction device and is connected to at least one of the household appliances by way of a wireless communication link. The fume extraction device can be an extractor hood, a table fan or a recessed fan, for instance. In this case the communication between the control device and a fume extraction device can take place directly for instance and the fume extraction device can be connected to the cooktop for communication purposes. Alternatively, it is also possible however for the control device to be connected to the cooktop for communication purposes and for the cooktop in turn to be connected to the fume extraction device for communication purposes. Within the scope of the invention, the control device is finally connected both to the fume extraction device and also to the cooktop. The connection(s) of the control device to the cooktop and/or the fume extraction device can be wired connection(s) or wireless connection(s).

Furthermore, the control device can be arranged at a similar height to an extractor hood above the worktop and preferably the cooktop. The identification of objects and/or gestures is possible by means of the control unit. The user preferably interacts with the fume extraction device by way of gestures. The operation of the cooktop and other networked appliances can take place by way of a control panel which is preferably located in the detection area of the control device.

The control device can further comprise a prediction unit for predicting a probability of a fire developing, wherein the prediction unit is designed to predict the probability on the basis of the evaluation result.

The detection unit further preferably comprises at least one camera, a control monitoring and/or at least one sensor. The camera is preferably an infrared camera and/or a depth camera. In addition, the camera can also be configured to record videos. The sensors can comprise for instance microphone arrays for supporting the detection of movements of the user and/or infrared sensors for determining temperatures. The control monitoring of the detection unit preferably represents a monitoring unit, which monitors control commands from a controller of the fume extraction device and/or the cooktop. In this way, the set power level of the fume extraction device or the cooktop or the cooking zones of the cooktop can be detected, for instance.

The units of the control device can be embodied at least in part as a program. Moreover, the units of the control device can be combined at least in part. Furthermore, units of the control device can be formed at least in part by units of one of the household appliances. For instance, at least one part of the detection unit or the control unit is formed by units on the cooktop or the fume extraction device, for instance an extractor hood.

The inventive method is preferably carried out with an inventive control device. The present invention is explained again below with reference to the appended drawings, in which:

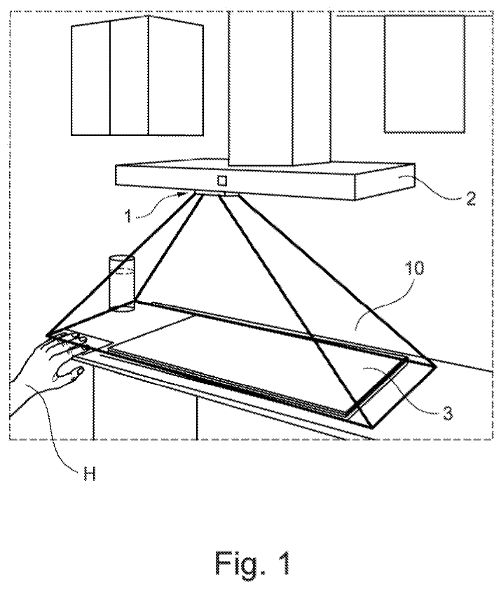

FIG. 1 shows a schematic representation of an embodiment of the inventive control device in a cooking system;

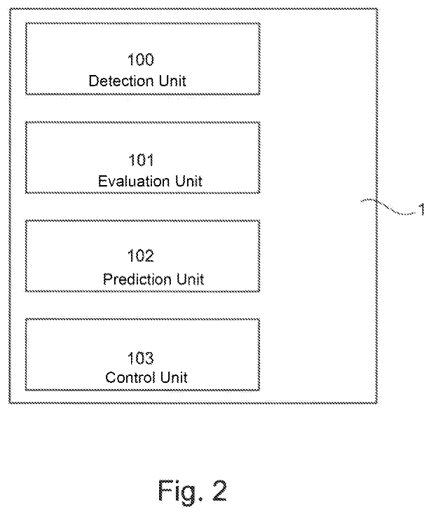

FIG. 2 shows a schematic block diagram of the units of an embodiment of the control device, and

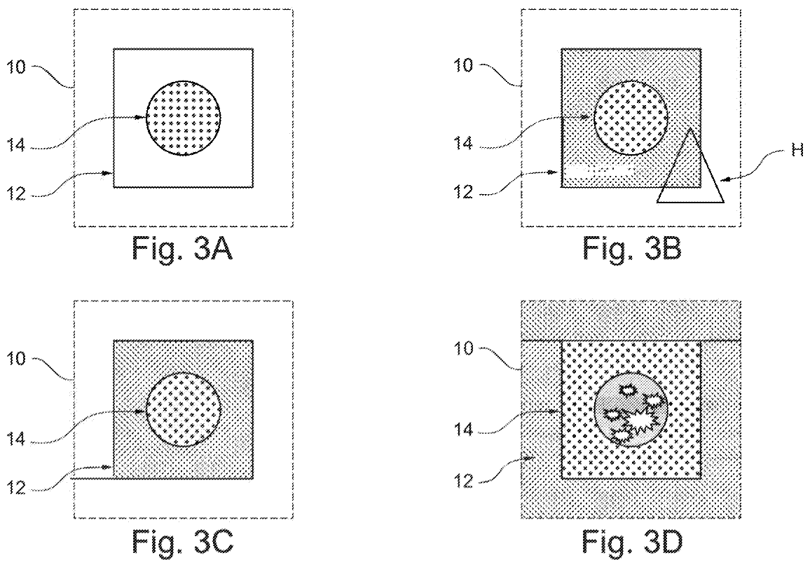

FIG. 3A-3D show schematic representations of a detection of movements and indicators for developments of smoke according to the inventive control device and the inventive method.

The inventive method can be carried out for instance with a control device 1 shown in FIGS. 1 and 2, wherein the control device 1 is preferably integrated in the extractor hood 2 and wherein a detection unit 100 of the control device 1 comprises a detection area 10, in which a cooktop 3 and optionally a control panel are arranged. The control panel is presently being operated by a hand H according to FIG. 1. A cooking level for a cooking zone and, if applicable, an operating state of the extractor hood 2, for instance a fan power, can be set and adjusted accordingly by way of the control panel, wherein the detection unit 100 is designed to detect a movement of the hand H or another object. For instance, the detection unit 100 can to this end contain a camera, which continuously detects movements and is optionally embodied as a video camera.

In this way, the detection unit 100 is used to detect decision criteria which relate to the movement of an object, for instance a hand H of the user in the area of a cooking receptacle, wherein indicators are further detected for a development of smoke. On the basis of an evaluation in an evaluation unit 101 of the detected decision criterion, it is accordingly possible to predict whether a development of smoke is to be expected, so that in the absence of a user and a corresponding movement over a predetermined time, a warning signal can be output.

On account of the detected indicator for a development of smoke and an absence of a movement in the area of the cooktop 3, it can accordingly be determined whether a potential danger is imminent, if a user is not currently present during the cooking process. Therefore, an indicator of a slight development of smoke cannot represent a specific or acute danger, but instead only bring about minimal pollution of the kitchen air. A relatively significant development of smoke can however also indicate a development of fire, so that an immediate reaction is needed in order to prevent a fire. Such a prediction taking into account an evaluation result can take place for instance in an optional prediction unit 102 of the control device 1. Accordingly, a warning signal and optionally control for the extractor hood 2 is output by a control unit 103 in order to lower a power of the extractor hood 2 or a fan level according to the predicted development of smoke or fire, in order thus to prevent fueling a fire and significantly polluting the kitchen air.

Therefore an automatic system reaction can take place so that no unnecessary reaction delay exists. A potential danger is therefore avoided as far as possible, thereby significantly improving safety when using a cooking system. If a movement of the hand or an object is detected, however, it can be assumed herefrom that a user is present during the cooking process and responds accordingly to a development of smoke. A warning signal can therefore be omitted or suppressed. During a normal cooking process, a user is consequently not hindered or unnecessarily restricted by the monitoring.

Furthermore, when a movement of an object is detected, provision can likewise be made for an evaluation of an indicator to be paused in order thus to save energy. The detection and evaluation of indicators is in such a case started automatically once a movement is no longer detected, wherein this can take place with a minimal delay compared with the predetermined time.

FIGS. 3A to 3D show examples of detections of movements and indicators for developments of smoke, which either trigger an output of a warning signal or wherein no warning signal is output. Therefore, FIG. 3A shows a detection area 10 with the dashed lines, which is detected by a camera of a control device (not shown), which is fastened to a lower side of an extractor hood (not shown), for instance. In the detection area, a cooking zone 12 of a cooktop is found, wherein the cooktop can accordingly comprise a number of cooking zones and the area preferably comprises the entire cooktop, preferably including the control panel of the cooktop and/or a border region of the cooktop. A cooking receptacle 14 in which a food to be cooked is located is positioned on the cooking zone 12.

As shown with the dotted hatching, a detection unit or the camera of the control device detects that a change in contrast or a brightness course, which differs from the remaining detection area 10, is located above the food to be cooked. Accordingly, in an evaluation unit, the presence of a specific temperature and/or type of food to be cooked or also a minimal development of smoke is ascertained. Because this does not exceed any stored threshold value or characteristic curve, no warning signal is output despite the absence of a detected object, especially as it was determined that there was no danger to the user and/or no handling requirement.

In FIG. 3B, the change in contrast within the cooking receptacle 14 or above the food to be cooked has intensified, and a change in contrast or a changed brightness course is likewise detected above the cooking zone 12. In addition or alternatively, a change in the detection area 10 which does not match with the cooking receptacle 14 can likewise be used accordingly as an indicator of a development of smoke. Accordingly, the presence of a development of smoke, which spreads and may thus not only pollute the kitchen air but is likewise an indication that a fire may develop in the foreseeable future, is ascertained in an evaluation unit. The detection unit does however detect a movement or the presence of a hand H, so that a warning signal is suppressed accordingly, especially as it is assumed that the user is aware of a possible development of smoke and responds correspondingly hereto for instance by closing a lid of the cooking receptacle 14, lowering the fan power of the fume extraction device and/or the cooking level of the cooking zone 12, for instance.

In the absence of a movement or a hand detection, it is however assumed that the user is not present or is not located in the area of the cooking system or the cooktop. If no movement is detected accordingly for a predetermined time and a smoke development was determined, as shown in FIG. 3C, a warning signal is output accordingly from the control device in order thus to render a user aware of a potentially imminent danger. The warning signal can be output here for instance by means of a light or lighting apparatus provided as a visual signal to an extractor hood. Similarly, an acoustic alarm signal can be output for instance by means of a buzzer. A notification to the user is further preferably carried out by means of a communication module provided in the control device or in the fume extraction device, wherein for instance a push message is transferred to an application or app installed in the terminal of the user. The push message can optionally obtain here a current video recording of the detection unit or the camera so that the user can likewise visually estimate the danger.

In order to avoid a reaction delay, the warning signal can further comprise a control and/or regulating signal for controlling an operating state of a fume extraction device and/or the cooktop. In other words, when a development of smoke is detected and an imminent danger is determined by means of a provided data link, a cooking level is lowered or the entire cooktop is switched off. Similarly, in order to prevent fueling a fire, a fan power of the fume extraction device is lowered or the extractor hood is switched off so that an initial fire cannot spread by way of the fume extraction device and is choked.

Such a development of fire is shown schematically in FIG. 3D, wherein the change in contrast has propagated across the entire area and wherein a strong smoke development was determined on the basis of the contrast. Similarly, significant changes in contrast and in some places a high brightness are likewise determined within the cooking receptacle 14; these indicate an imminent fire. In such a case, the predetermined time, during which no movement is detected, is currently restricted to a minimum value, so that a user is immediately notified and control of the fume extraction device or the cooktop takes place immediately. Provision can likewise be made for this predetermined time to correspond here to a sampling rate, so that a warning signal is output with each absence of a movement. Optionally, the warning signal can be output continuously until a detected fire is choked or a probability of a development of fire no longer exceeds a corresponding threshold value.

### LIST OF REFERENCE CHARACTERS

1 control device
10 detection area
12 cooking zone
14 cooking receptacle
100 detection unit
101 evaluation unit
102 prediction unit
103 control unit
2 extractor hood or fume extraction device
3 cooktop
H hand

1-13. (canceled)

14. A method for monitoring a cooking process, said method comprising:
detecting a movement of an object in an area of a cooktop;
evaluating the detected movement for a predetermined time;
detecting an indicator of a development of smoke in the area of the cooktop;
evaluating the indicator; and
outputting a warning signal when a movement for the predetermined time is absent and the indicator is present.

15. The method of claim 14, wherein the warning signal comprises an information output and/or a notification to a user and/or a control and/or regulating signal for controlling an operating state of a fume extraction device and/or the cooktop.

16. The method of claim 14, wherein the indicator is a predetermined change in contrast and/or a predetermined brightness of a subarea of a detected image within a predetermined time, wherein the image comprises the area of the cooktop.

17. The method of claim 16, wherein the detected image is an infrared image or an image with overlaid infrared data.

18. The method of claim 14, further comprising determining a probability of a development of fire based on an evaluation result, wherein the warning signal corresponds to the determined probability.

19. The method of claim 14, further comprising determining a probability of a development of fire based on detected sensor data.

20. The method of claim 19, wherein the sensor data is a member selected from the group consisting of sensor data of a measured air quality, a measurement of dust particles and/or soot particles, and a measurement of the air humidity and/or an ambient temperature measurement.

21. The method of claim 14, further comprising determining a probability of a development of fire based on a detected temperature and/or type of food to be cooked which is located in a cooking receptacle on the cooktop.

22. The method of claim 14, further comprising determining a probability of a development of fire based on a current recipe section of a stored recipe.

23. A control device for a cooking system, said control device comprising:
a detection unit designed to detect a movement of an object in an area of a cooktop and to detect an indicator of a smoke development in the area of the cooktop;
an evaluation unit designed to evaluate the detected movement over a predetermined time and to evaluate the indicator; and
a control unit designed to output a warning signal when a movement for the predetermined time is absent and the indicator is present.

24. The control device of claim 23, constructed for integration in an extractor hood and/or representing a module designed to be fastened to the extractor hood, and further comprising a communication unit for wirelessly transmitting data between the control device and the extractor hood and/or between the control device and the cooktop.

25. The control device of claim 23, wherein the detection unit comprises at least one member selected from the group consisting of a camera, a control monitoring and a sensor.

26. The control device of claim 23, designed to execute a method as set forth in claim 14.

27. A fume extraction device, comprising a control device, said control device comprising a detection unit designed to detect a movement of an object in an area of a cooktop and to detect an indicator of a smoke development in the area of the cooktop, an evaluation unit designed to evaluate the detected movement over a predetermined time and to evaluate the indicator, and a control unit designed to output a warning signal when a movement for the predetermined time is absent and the indicator is present.

28. The fume extraction device of claim 27, constructed in a form of an extractor hood.

29. The fume extraction device of claim 27, wherein the control device is integrated in the fume extraction device.

30. The fume extraction device of claim 28, wherein the control device comprises a communication unit for wirelessly transmitting data between the control device and the extractor hood and/or between the control device and the cooktop.

31. The fume extraction device of claim 27, wherein the detection unit comprises at least one member selected from the group consisting of a camera, a control monitoring and a sensor.

32. The fume extraction device of claim 27, wherein the control device is designed to execute a method for monitoring a cooking process by detecting a movement of an object in an area of a cooktop, evaluating the detected movement for a predetermined time, detecting an indicator of a development of smoke in the area of the cooktop, evaluating the indicator, and outputting a warning signal when a movement for the predetermined time is absent and the indicator is present.
